(19) United States
(12) Patent Application Publication
(10) Pub. No.: US 2022/0227538 A1
(43) Pub. Date: Jul. 21, 2022

(54) METHODS, ASSEMBLIES, AND COMPOSITIONS FOR SOLID BEVERAGE FLAVORANTS

(71) Applicant: Teaspressa, LLC, Tampe, AZ (US)

(72) Inventor: Allison DeVane, Phoenix, AZ (US)

(21) Appl. No.: 17/579,255

(22) Filed: Jan. 19, 2022

Related U.S. Application Data
(60) Provisional application No. 63/139,229, filed on Jan. 19, 2021.

(51) Int. Cl. B65D 25/54; B65D 85/60; B65D 5/38

(52) U.S. Cl. CPC B65D 25/54; B65D 2301/20; B65D 5/38; B65D 85/60

(57) ABSTRACT

A flavorant composition and sleeve and tray assembly for storing same may include a transparent sleeve having a rectangular geometry and defining a cavity between sidewalls and end walls. A transparent tray may be disposed within the cavity. A plurality of cubes may include a flavorant with a surface texture of the flavorant is visible through the tray and the sleeve. The tray may be visually obscured by the sleeve and the surface texture of the flavorant. The transparent tray may include a base, a first sidewall extending from a first edge of the base, a second sidewall extending from a second edge of the base opposite the first edge, and an end stop extending from a third edge of the base extending between the first edge and the second edge, wherein the base, the first sidewall, and the second sidewall define a channel terminated by the end stop.

### CROSSREFERENCE TO RELATED APPLICATIONS

This application claims priority to U.S. Provisional Patent Application No. 63/139,229 entitled “SOLID BEVERAGE FLAVORANT COMPOSITIONS AND METHODS OF MAKING SOLID BEVERAGE FLAVORANT COMPOSITIONS” and filed on Jan. 19, 2021, which is incorporated herein by reference for any purpose.

### FIELD

The present disclosure relates to methods, assemblies, and compositions for solid beverage flavorants.

### BACKGROUND

Flavored beverages are traditionally made by adding one or more flavorings to a liquid. In some instances, the liquid can be water, such as for making tea or coffee, the liquid can be alcohol to create a flavored cocktail or other alcoholic drink. In some instances, a recipe may call for several different ingredients requiring multiple steps to produce the desired drink.

Currently available flavorings are produced in powder form or are frozen or refrigerated. Frozen beverage cubes can result in a diluted or weaker tasting beverage than desired. A need exists for a room temperature stable solid beverage flavorant composition that does not dilute or weaken the flavor of a desired beverage and provides consistently flavored drinks.

### SUMMARY

A sleeve and tray assembly may include a transparent sleeve having a rectangular geometry and defining a cavity between four sidewalls and two end walls, according to various embodiments. A transparent tray may be disposed within the cavity. The transparent tray may include a base, a first sidewall extending from a first edge of the base, a second sidewall extending from a second edge of the base opposite the first edge, and an end stop extending from a third edge of the base extending between the first edge and the second edge, wherein the base, the first sidewall, and the second sidewall define a channel terminated by the end stop. A plurality of cubes may include a flavorant with a surface texture of the flavorant visible through the tray and the sleeve. The tray may be visually obscured by the sleeve and the surface texture of the flavorant.

In various embodiments, the flavorant may comprise sugar, flavoring, water, emulsion, dye. The flavorant may be stable at room temperature. The flavorant may include a garnish or dehydrated botanical ingredient that is visible through the tray and the sleeve. The flavorant may be formed into cubes with substantially smooth surfaces. The surfaces may show the surface texture of the flavorant. The first sidewall of the tray may be between 0 millimeter and 3 millimeters shorter than the sidewall of the sleeve adjacent the first sidewall. An edge of the first sidewall of the tray may contact one of the sidewalls of the sleeve. The tray may comprise rounded corners to reduce interference in response to insertion of the tray into the cavity defined by the sleeve. The end stop of the tray may urge the cubes out of the sleeve in response to the tray translating out of the sleeve. A tab may be formed integrally with the base of the tray and may extend from the sleeve in response to the sleeve and tray assembly being in a closed position. The tray may be configured to translate out of the sleeve in response to a pulling force exerted on the tab. The tab may define an opening to hang the sleeve and tray assembly.

A sleeve and tray assembly may include a sleeve defining a cavity between the sleeve sidewalls and the sleeve end walls, according to various embodiments. A transparent tray may be disposed within the cavity. The transparent tray may include a base, a first sidewall extending from a first edge of the base, a second sidewall extending from a second edge of the base opposite the first edge, and an end stop extending from a third edge of the base. The base, the first sidewall, and the second sidewall may define a channel terminated by the end stop. Cubes may be disposed in the channel.

In various embodiments, the cubes may have substantially smooth surfaces including a surface texture of at least one of sugar, a garnish, or a botanical ingredient. The sleeve and the cubes may visually obscure the edges of the tray in response to the sleeve and tray assembly being in a closed configuration.

A method of packaging a solid beverage flavorant may include the step of placing a mold comprising individual sections onto a tray, according to various embodiments. The method may include combining one or more dehydrated botanical ingredients and one or more wet ingredients to form a mixture. The mixture may be packed into an individual section of the mold having a cuboid geometry. An exposed surface of the mixture may be smoothed to form a substantially smooth surface. The mixture may be dried to form a solid beverage flavorant composition having a cuboid geometry with substantially smooth surfaces. The solid beverage flavorant composition may be stable at room temperature.

In various embodiments, the method may include placing a dehydrated botanical ingredient or garnish into the individual section of the mold to expose the dehydrated botanical ingredient or garnish from the substantially smooth surfaces. The mixture may be dried in a dehydration apparatus at 65° C. for 8 hours. The solid beverage flavorant composition may be placed into a tray having a rectangular base, two rectangular sidewalls extending from the base, and a rectangular end stop extending from the base. The method may also include sliding the tray containing the solid beverage flavorant into a sleeve. The tray and the sleeve may be transparent or translucent.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1 illustrates a process flow for a solid beverage flavorant composition, in accordance with various embodiments.

FIG. 2 illustrates a perspective view of a solid beverage flavorant in a sleeve and tray assembly, in accordance with various embodiments.

FIG. 3A illustrates a sleeve and tray in a flat configuration, in accordance with various embodiments.

FIG. 3B illustrates a sleeve and tray arranged in a 3-dimensional configuration, in accordance with various embodiments.

FIG. 4A illustrates a top-side perspective view of sleeve and tray assembly with the tray extending from the sleeve, in accordance with various embodiments.

FIG. 4B illustrates an end perspective view of a distal end of a sleeve and tray assembly with the tray extending from the sleeve, in accordance with various embodiments.

FIG. 5A illustrates a top-side perspective view of a sleeve and tray assembly with the tray contained within the sleeve, in accordance with various embodiments.

FIG. 5B illustrates an end perspective view of a distal end of a sleeve and tray assembly with the tray contained within the sleeve, in accordance with various embodiments.

FIG. 5C illustrates a detailed view of a sleeve and tray assembly with the tray contained within the sleeve, in accordance with various embodiments.

FIG. 6 illustrates a front elevation view of a solid beverage flavorant arranged in a sleeve and tray assembly, in accordance with various embodiments.

### DETAILED DESCRIPTION

The detailed description of exemplary embodiments herein makes reference to the accompanying drawings which show exemplary embodiments by way of illustration and their best mode. While these exemplary embodiments are described in sufficient detail to enable those skilled in the art to practice the inventions, it should be understood that other embodiments may be realized and that logical, chemical, and mechanical changes may be made without departing from the spirit and scope of the inventions. Thus, the detailed description herein is presented for purposes of illustration only and not of limitation. For example, the steps herein recited in any of the method of process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

In various embodiments, a solid beverage flavorant composition is provided. In embodiments, preparing a flavored beverage using a solid beverage flavorant composition may improve the ratio of ingredients and may allow for consistency in a prepared beverage. In embodiments, a solid beverage flavorant composition may reduce any variation between a flavored beverage prepared multiple times resulting from inaccurate measuring and the addition of multiple separate ingredients. A single use solid beverage flavorant composition may result in a consistently and authentically flavored beverage.

In embodiments, a solid beverage flavorant composition may be used by a consumer in any setting. In embodiments, a solid beverage flavorant composition may be prepared by a barista or the like in a coffee or tea establishment. In embodiments, a solid beverage flavorant composition may be prepared by a bartender, mixologist or the like in a bar, restaurant, public house, club or the like. In embodiments, a solid beverage flavorant composition may be prepared by a consumer in a residential home.

In various embodiments, a solid beverage flavorant composition may provide a consumer the ability to prepare multiple flavored beverages at home without the need of a mixologist or barista, or the associated cost of having a mixologist or barista prepare a flavored drink. In embodiments, a solid beverage flavorant composition may allow a consumer the ability to create a flavored beverage that suits their specific tastes. In embodiments, a consumer may either reduce or increase the volume of an added liquid, such as tea, coffee or alcohol, to the addition of a solid beverage flavorant composition to adjust the final flavor to suit an individual taste. In embodiments, a consumer may use a solid beverage flavorant composition to prepare multiple beverages without the usual time, number of multiple different ingredients, or multiple tools and hardware, or measurement steps, or mixing steps typically involved in preparing multiple different flavored beverages.

In various embodiments, the solid beverage flavorant composition may be stable at room temperature. In various embodiments, a solid beverage flavorant composition may not degrade without storage at either refrigerated or frozen conditions or without freeze-drying to maintain the integrity and flavor of the solid beverage flavorant composition. A solid beverage flavorant composition may be prepared with a higher amount of non-perishable or dry ingredients and the use of liquid or perishable ingredients may be reduced to allow for storage at room temperature. A solid beverage flavorant composition may be stored at room temperature for prolonged periods of time without any effect on the integrity or stability of the solid beverage flavorant composition or the resulting flavor. In embodiments, a solid beverage flavorant composition may be stored at room temperature for at least about twelve (12) months. In embodiments, a solid beverage flavorant composition may be stored at room temperature for at least about twelve (12), eighteen (18), or twenty-four (24) months. In embodiments, a solid beverage flavorant composition may be stored at room temperature for at least about 1, 2, 3, 4, 5, 6, 7, 8, 9, or 10 years or more.

In embodiments, the solid beverage flavorant composition may be added to a liquid of choice to flavor the liquid. In embodiments, the solid beverage flavorant composition may be stored at room temperature and added to the liquid at room temperature. In embodiments, a solid beverage flavorant composition may dissolve or disperse into a liquid without diluting the liquid or the final flavor or taste.

In various embodiments, a solid beverage flavorant composition may be used to flavor any liquid or solution. In embodiments, a liquid may include, but is not limited to, water (for example, still, carbonated or sparkling), tea, coffee (for example, black coffee, flavored coffee, latte, Frappuccino, macchiato, and the like), juice, cocoa, hot chocolate, milk, dairy-free milk (for example, almond milk, coconut milk, cashew milk, soy milk and the like), matcha (for example, green tea powder) or any type of alcohol including, but not limited to any liquor, beer, wine, champagne and the like. In embodiments, the solid beverage flavorant composition may dissolve or disperse in a liquid or solution.

In embodiments, a solid beverage flavorant composition may be comprised of sugar, a flavoring, water, emulsion, a dye and any combination thereof.

In various embodiments, sugar may include, but is not limited to, refined sugar. In embodiments, sugar may include, but is not limited to, white sugar, bleached sugar, unbleached sugar, brown sugar, natural sugar, raw sugar, or any combination thereof.

In various embodiments, a solid beverage flavorant composition may include one or more flavorings. In embodiments, a flavoring may be a powder, an oil, extract, an emulsion or any combination thereof. In embodiments, a flavoring may be any flavor or combination of flavors. A flavoring may include, but is not limited to, orange, lemon, pumpkin, pumpkin spice, clove, vanilla, lavender, rose, caramel, salted caramel, strawberry, raspberry, peach, grapefruit, apple, apple cider, peppermint, white chocolate, mocha, beet, black cherry, ginger, lime, agave, blueberry, banana, cranberry, honey, ancho, turmeric, matcha, latte, nut (for example, hazelnut, peanut, cashew, peanut butter, almond) and cinnamon. Other flavorings may include, but are not limited to, ground ginger, allspice, vermouth extract, angostura bitters, spiced cherry bitters, orange bitters, arcadia orange, olive brine, crème de menthe, triple sec extract, cinchona bark, lime leaf iconic mixer, and ginga syrup iconic mixer. A solid beverage flavorant composition may include any one or more flavorings in any combination.

In various embodiments, a solid beverage flavorant composition may be flavored to produce a cocktail or specialty flavored beverage and may include, but not be limited to, seasonal flavorings (for example, pumpkin in the fall or autumn, spiced flavoring for the holidays). In embodiments, a solid beverage flavorant composition may include, but is not limited to, latte, Frappuccino, macchiato, matcha, Moscow mule, old fashioned, Manhattan, mint julep, mojito, cosmo, cosmopolitan, mimosa, London fog, black rose, Irish cream, beer, shandy, black cherry anise, martini, margarita, or any combination thereof.

In various embodiments, the type of flavoring may affect the structure and resulting flavor of the solid beverage flavorant composition. In embodiments, a powder flavoring may result in the ability to reduce the volume of wet ingredients 104 that may be added to a solid beverage flavorant composition. In embodiments, an oil flavoring may result in improving the ability of a dehydrator apparatus to dry the solid beverage flavorant composition and may produce a solid beverage flavorant composition that is stable at room temperature.

In embodiments, a solid beverage flavorant composition may include one or more nutritional supplements or dietary supplements. In embodiments, a nutritional or dietary supplement may include, but is not limited to, vitamins, minerals, proteins, amino acids, herbs or other botanicals, or other nutritional supplements. In embodiments, a nutritional or dietary supplement may include, but is not limited to, acai, antioxidants, arginine, vitamin A, beetroot, bee pollen, beta-alanine, beta-carotene, biotin, vitamin B1, vitamin B12, caffeine, calcium, chamomile, cinnamon, clove, cod liver oil, coenzyme Q10, cranberry, creatine, vitamin C, dandelion, vitamin D, echinacea, evening primrose oil, elderflower, elderberry, vitamin E, garlic, ginger, ginkgo, ginseng, glucosamine, goji, grape, hibiscus, horse chestnut, iron, vitamin K, lavender, licorice root, magnesium, manganese, mangosteen, melatonin, omega fatty acids, oregano, pea protein, peppermint oil, pomegranate, probiotics, rose hip, sage, soy, St. John's wort, thiamin, turmeric, whey, wheatgrass, zinc, and the like, or any combination thereof.

In embodiments, a solid beverage flavorant composition may include a coloring agent. In embodiments, a coloring agent may be used to provide a color to a drink prepared using a solid beverage flavorant composition. In embodiments, a coloring agent may be a botanical or natural coloring agent. In embodiments, a coloring agent may be a powder, gel or liquid. In embodiments, a coloring agent may include, but not be limited to, pitaya powder (for example, dragonfruit powder), butterfly pea powder, beetroot powder, activated charcoal powder, matcha powder, spirulina powder (for example, blue spirulina), dunaliella sauna powder, curcumin powder, and the like. In embodiments, one or more coloring agents in any combination may be added to a solid beverage flavorant composition.

In embodiments, Cannabis, Cannabis-derived, hemp or Cannabis extract may be added to a solid beverage flavorant composition. In embodiments, Cannabis may include, but not be limited to, any part of the Cannabis sativa plant. In embodiments, one or more cannabinoids may be added to a solid beverage flavorant composition. In embodiments, a cannabinoid may include, but is not limited to, tetrahydrocannabinolic acid (THCA), tetrahydrocannabinol (THC), cannabidolic acid (CBDA), cannabidiol (CBD), cannabinol (CBN), cannabigerol (CBG), cannabichromene (CBC), tetrahydrocannabivarin (THCV), cannabidivarin (CBDV), and the like, and any combination thereof. In embodiments, a cannabinoid may be extracted from the Cannabis sativa plant or may be synthetically manufactured. In embodiments, hemp may include, but not be limited to, hemp seed products (for example, hulled hemp seed, hemp seed protein powder, hemp seed oil), derivatives, extracts, cannabinoids, isomers, acids, salts, and salts of isomers. In embodiments, hemp may have a delta-9 tetrahydrocannabinol concentration of 0.3% or less on a dry weight basis.

In various embodiments, a solid beverage flavorant composition may include one or more dyes. The one or more dyes may be included to provide an authentic color to the solid beverage flavorant composition such that once dissolved in a liquid or solution, an authentic colored beverage may be produced. In embodiments a dye may include, but is not limited to, blue dye, red dye, pink dye, red/pink dye, orange dye, eggshell dye, yellow dye, green dye, copper dye (or copper food paint), caramel dye, or any combination thereof.

In various embodiments, dehydrated botanical ingredients may be added to a solid beverage flavorant composition. In embodiments, a dehydrated botanical ingredient such as a leaf, flower part (for example, petals), bark (for example, cinnamon bark), peppercorn or peel (for example, orange, lemon or grapefruit peel) may be added. In embodiments, one or two flower petals or several smaller portions of a flower may be added to a solid beverage flavorant composition.

In various embodiments, further edible ingredients may be added to a solid beverage flavorant composition. In embodiments, edible glitter may be added to enhance the flavor or add to the authenticity of a solid beverage flavorant composition.

In embodiments, a solid beverage flavorant composition may not use a binder or other excipient to maintain the shape and integrity of the solid beverage flavorant composition. In embodiments, a solid beverage flavorant composition does not include added fat or an emulsifier to retain the shape of the solid beverage flavorant composition or the flavor. The addition of a binder or other such excipient may result in a solid beverage flavorant composition not being dispersed in a uniform manner in the liquid or solution into which it is added or may alter the taste or flavor of the resulting beverage. In embodiments, a solid beverage flavorant composition excludes a binder.

In embodiments, a solid beverage flavorant composition may include tartaric acid (for example, dihydroxybutanedioic acid, or salt for example, cream of tartar). In embodiments, the addition of tartaric acid may add a sharp tart flavor to a solid beverage flavorant composition. In embodiments, the addition of tartaric acid may aid in the forming of a solid beverage flavorant composition structure. In embodiments, the presence of tartaric acid may act as a preservative and increase the stability of a solid beverage flavorant composition stored at room temperature. In embodiments, the addition of tartaric acid may inhibit, reduce or prevent bacterial growth in a solid beverage flavorant composition.

In various embodiments, a method for preparing a solid beverage flavorant composition is provided. In various embodiments, a solid beverage flavorant composition may be formed as a cube structure. In embodiments, a cube structure may have substantially smooth surfaces. In embodiments, a cube structure may be stable at room temperature. In embodiments, a cube structure be stored without refrigeration or freezing temperatures and still maintain the integrity, structure, and flavor of the cube or solid beverage flavorant composition.

In various embodiments, a solid beverage flavorant composition may be a cube structure of a certain size. In embodiments, a solid beverage flavorant composition may be prepared as a cube measuring two inches in width, two inches in length and two inches in height (for example, 2×2×2 inches). In embodiments, a solid beverage flavorant composition may be prepared in a strip of individual cube structures. A strip of individual cube structures may measure ⅝ inch in width, ⅝-inch height and 4¼ inches in length (for example, ⅝×⅝×4¼ inches). In embodiments, a strip of individual cube structures may measure ⅝ inch in width, ⅝-inch height and 8 inches in length (for example, ⅝×⅝×8 inches). In embodiments, a solid beverage flavorant composition may have the appearance of a sugar cube. In embodiments, a sugar cube may have substantially smooth surfaces.

In various aspects, a method for preparing a solid beverage flavorant composition may comprise a multistage process with a series of discontinuous steps to prepare a solid beverage flavorant composition where the solid beverage flavorant composition is a solid cube.

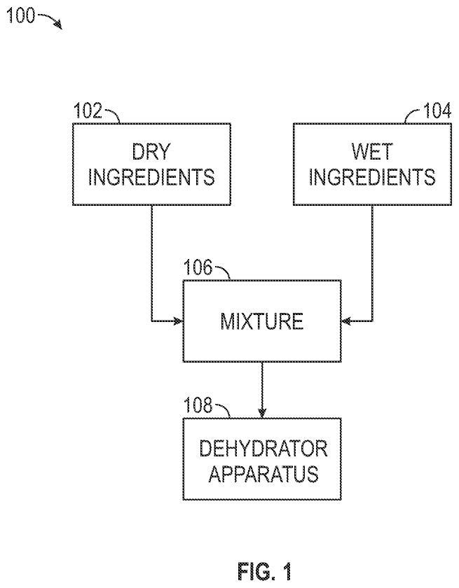

Referring now to FIG. 1, a method 100 of preparing a solid beverage flavorant composition is shown, in accordance with various embodiments. In embodiments, a solid beverage flavorant composition may be prepared using a mold having one or more individual sections. In embodiments, a mold may be placed into a tray during the preparation process. In embodiments, one or more individual pieces of a dehydrated botanical ingredient or garnish may be placed into one or more individual sections within the mold. In embodiments, one or more dry ingredients 102 are combined together. In embodiments, one or more wet ingredients 104 are combined together. In embodiments, the wet ingredients 104 are added to the dry ingredients 102 and combined to form a mixture 106. In embodiments, the mixture 106 may be placed into one or more individual sections within the mold. In embodiments, the mixture 106 is placed into the mold to fill to the top surface of the mold. In embodiments, the mixture 106 is packed into the mold to compress the mixture 106 into the mold and form the shape of the mold. In embodiments, the top surface of the mixture 106 in the mold may be smoothed to form a substantially smooth surface at the top of the mold. In embodiments, the mold may be placed into a dehydration apparatus 108 to dry the mixture 106, remove the moisture and form a solid beverage flavorant composition.

In embodiments, the individual steps of the process of preparing a solid beverage flavorant composition may be performed at room temperature. In embodiments, the process of preparing a solid beverage flavorant composition may be performed under low humidity to remove any excess moisture present in the air from affecting the formation of the solid beverage flavorant composition.

In various embodiments, a dehydrated botanical ingredient or garnish may be added to a solid beverage flavorant composition. In embodiments, a dehydrated botanical ingredient can include, but is not limited to, an edible leaf, edible flower part (for example, petal), bark (for example, cinnamon bark), peel (for example, orange, lemon or grapefruit peel), or dried fruit (for example, freeze-dried fruit). In embodiments, one or more dehydrated botanical ingredients, for example, a flower petal, or several smaller portions or sections of a dry ingredient or garnish, for example, sections of several flower petals, may be added to a mold to produce a solid beverage flavorant composition having a dry ingredient contained within the structure. In embodiments, the addition of a dehydrated botanical ingredient or garnish may be added such that it is embedded in the structure of the solid beverage flavorant composition. A dehydrated botanical ingredient or garnish may be embedded throughout the structure of a solid beverage flavorant composition or may be embedded within one or more surfaces of a solid beverage flavorant composition. In embodiments, a dehydrated botanical ingredient or garnish may be added to the bottom surface of a mold and the solid beverage flavorant composition mixture 106 added on top of the dehydrated botanical ingredient or garnish. In embodiments, the dehydrated botanical ingredient or garnish does not alter the surface profile of a solid beverage flavorant composition and a solid beverage flavorant composition may retain a substantially smooth surface.

In various embodiments, other edible ingredients may be added to a solid beverage flavorant composition. In embodiments, edible ingredients include, but are not limited to, edible glitter. In embodiments, edible glitter may be any color.

In various embodiments, a solid beverage flavorant composition may include a design on the external surface of the solid beverage flavorant composition. In embodiments, a design may be a pattern, lettering, numbering, or a design representing an occasion or theme (for example, holiday theme, sports team, baby shower theme, bridal shower theme, and the like).

In various embodiments, the mixture 106 may be packed into a mold manually using hands, hand tools, or using mechanized tools or equipment. In embodiments, mechanical, hydraulic or pneumatic action may be used to pack the mixture 106 into a mold and form the solid beverage flavorant composition.

In various embodiments, a dehydration apparatus may be used to dry the mixture 106 to form a solid beverage flavorant composition in a mold. In embodiments, a dehydration apparatus may use hot air to remove moisture (for example, water) from a solid beverage flavorant composition. The dehydration apparatus may include a heating element that raises the temperature inside the apparatus and a fan that evenly circulates the heat to remove the moisture whilst preserving the flavor in the solid beverage flavorant composition. The removal of the moisture by the dehydration apparatus may also prevent any bacterial, yeast or mold growth on a solid beverage flavorant composition increasing its shelf-life and allowing for storage at room temperature for prolonged periods of time.

In various embodiments, a dehydrator may be used at a set temperature for a set amount of time to dry the mixture 106. In embodiments, a dehydrator may be used at about 50° C., 55° C., 60° C., 65° C., 70° C., 75° C., 80° C. or higher. A dehydrator may be used for about 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours or 24 hours to dry a mixture 106. In embodiments, a dehydrator may be used at 65° C. for 8 hours.

In embodiments, a dehydration apparatus may remove substantially all of the moisture from a solid beverage flavorant composition. In embodiments, a dehydration apparatus may remove about 80%, 85%, 90%, 91%, 92%, 93%, 94%, 95%, 96%, 97%, 98%, 99% or 100% of the moisture from a solid beverage flavorant composition. In embodiments, a dehydration apparatus may improve the surface texture of a solid beverage flavorant composition and produce a solid beverage flavorant composition having substantially smooth surfaces. In embodiments, the use of a dehydration apparatus to remove the moisture may result in the formation of a solid beverage flavorant composition having substantially smooth sides that does not degrade when stored at room temperature conditions for prolonged periods of time.

In various embodiments, a solid beverage flavorant composition is provided in a first packaging material. Packaging material may include a sleeve and tray assembly as described in greater detail below. In embodiments, a first packaging material may include one, two, three, four, five, six or more solid beverage flavorant compositions. In embodiments, a solid beverage flavorant composition in a first packaging material may be stored at room temperature without refrigerated or freezing conditions. In embodiments, a first packaging material may be prepared from plastic. In embodiments, plastic packaging material may be composed of high-density polyethylene, low density polyethylene, polyethylene terephthalate, polypropylene, polystyrene, polyvinyl chloride, or any combination thereof. In embodiments, a first packaging material may be produced as a rectangular cuboid structure or a single cube structure. In embodiments, a first packaging material may be composed of substantially transparent material to expose the solid beverage flavorant composition provided within. In embodiments, the full packaging material may be substantially transparent, or a partial section of the packaging material may be see through (e.g., transparent or translucent). In embodiments, a solid beverage flavorant composition may be provided in a first packaging material that is placed within a second packaging container. In embodiments, a second packaging container may be composed of plastic, paper, cardboard or any combination thereof. In embodiments, a second packaging material may be a box containing sections formed at a lower level to allow for insertion of the first packaging material. In embodiments, a second packaging material may be a pouch or a bag. A second packaging container may include a see-through section to expose the solid beverage flavorant compositions contained within the first packaging container. In embodiments, a second packaging container may include one or more first packaging containers. In embodiments, a second packaging container may include one, two, three, four, five, six or more first packaging containers, where the first packaging containers includes one, two, three, four, five or six solid beverage flavorant compositions. In embodiments, a second packaging material may further include a decorative element, for example a ribbon tied around the packaging material. In embodiments, the ribbon or other decorative element may be any color, shape, texture or material.

### EXAMPLES

### EXAMPLE 1

### Solid Beverage Flavorant Composition Production

It has been surprisingly discovered that a solid beverage flavorant composition may be prepared that is stable at room temperature. It has been discovered that using a dehydration apparatus to dry and dehydrate a solid beverage flavorant composition produces a stable solid beverage flavorant composition that retains its shape, appearance, and flavor when stored at room temperature for prolonged periods of time. The solid beverage flavorant composition produced using the method set forth are stable at room temperature for at least twelve (12) months. No change in taste, appearance or consistency of the solid beverage flavorant composition or the finished beverage product made using the solid beverage flavorant composition has been observed after storage at room temperature for at least twelve (12) months.

A solid beverage flavorant composition was prepared using the following method. The steps may be performed sequentially or may be performed in any order. Any one or more of the steps may be repeated. Standard sanitary procedures were followed for production, including, for example, handwashing and wearing of hairnets, gloves and face masks by personnel.

A tray was filled with one or more molds (for example, a tray may include 12 molds to a tray). A tray may be one batch that may yield about 18 molds. Optionally, garnish was placed into the mold, for example, about 1-3 pieces of garnish per cube were placed into an individual section of the mold. Sugar was weighed out for the batch being processed (for example; 1648 grams of sugar may be used per batch). The dry ingredients 102 other than sugar were added to the sugar (when applicable) as per the recipe. The dry ingredients 102 were mixed thoroughly. The wet ingredients 104 were combined separately from the dry ingredients 102. The wet ingredients 104 may include one or more of water, essential oils, and food coloring. The wet ingredients 104 were thoroughly mixed. The wet ingredients 104 were added to the dry ingredients 102 and mixed to combine and form a mixture 106 of the appropriate consistency. For example, the mixture 106 may resemble a wet beach sand in texture and any added color may be evenly distributed. The mixture 106 was mixed via hand. The mixture 106 was sprayed lightly with water and pressed into the molds using an acrylic tamp. The molds were packed to fill the molds and tools to set the mixture 106 to form a solid beverage flavorant composition. The surface of the mixture 106 was smoothed to form a substantially smooth surface. The mold was transferred to a clean tray for drying. The molds were either dried on drying racks or placed into a dehydrator to dry.

The molds were placed into a dehydrator set at 65° C. and dried for at least 8 hours. In some cases, the solid beverage flavorant compositions were dried in the dehydrator for more than 8 hours. The dehydration step resulted in a solid beverage flavorant composition having a smooth even surface around the resulting cube. The resulting solid beverage flavorant compositions had the appearance of a sugar cube with a smooth surface. As used herein, a substantially smooth surface of a cube of flavorant may be a flat surface that includes the texture of sugar, the texture of exposed garnish, or the texture of exposed botanical ingredients.

The solid beverage flavorant compositions were packaged in various packaging, for example, as a singular solid beverage flavorant compositions (for example, sugar cube), in a strip of six or twelve solid beverage flavorant compositions, or in a see-through bag. The packaging was wrapped with a ribbon, for example, gold, silver or copper ribbons. The strip of solid beverage flavorant compositions may be placed into a box or see-through bag to form a kit of solid beverage flavorant compositions of different flavors.

### EXAMPLE 2

### Stability of Solid Beverage Flavorant Compositions

The stability of solid beverage flavorant compositions at room temperature is tested using industry standard testing protocols. The stability of the solid beverage flavorant compositions is tested under various temperature and humidity conditions over time to determine the stability of the solid beverage flavorant compositions. Parameters including, but not limited to, material degradation, active ingredient stability, shelf-life evaluation, raw material and chemical stability, sensory evaluation (for example, odor, flavor, appearance, texture, color and taste), and microbiological testing may be determined under various conditions.

A long term, intermediate and/or accelerated stability study may be performed to determine the shelf-life stability of the solid beverage flavorant compositions over time. The solid beverage flavorant compositions are incubated at 25° C., 30° C., and/or 40° C. The temperature may be varied at ±2° C. The relative humidity (RH) may be varied at 60% , 65%, and/or 75%. The relative humidity may be varied at ±5%.

The solid beverage flavorant compositions may be stored at the following temperature and humidity conditions.

TABLE 1

| Study | Storage Condition | Time Period |
|---|---|---|
| Long Term | 25° C. ± 2° C./60% RH ±5% or | 12 months |
| | 30° C. ± 2° C./65% RH ±5% | |
| Intermediate | 30° C. ± 2° C./65% RH ±5% | 6 months |
| Accelerated | 40° C. ± 2° C./75% RH ±5% | 6 months |

Samples may be taken at time zero and after 1 week, 2 weeks, 3 weeks, 4 weeks, 5 weeks and 6 weeks storage at the various temperature and RH. The solid beverage flavorant compositions may be stored for 1 month, 2 months, 3 months, 4 months, 5 months, 6 months and up to and including 12 months. Samples may be taken each week for weeks 1 to 4 and each month for months 2 to 6. The samples are compared against the sample at time zero and any change in stability is determined. A change in stability may be measured as degradation of the solid beverage flavorant composition, or a reduction or change in the flavor, texture, color or taste of a solid beverage flavorant composition.

Microbiological growth is determined using standard techniques to measure common microbes such as bacteria. The presence of pathogenic bacteria such as Enterobacteriaceae, Escherichia coli, Clostridium perfringens, Bacillus cereus and other Bacillus species, Vibrio parahaemolyticus, Campylobacter spp., Salmonella spp. and Listeria monocytogenes may be tested. The acceptable levels of bacteria present in a solid beverage flavorant composition may be either not detected (ND) or at or below 10² to 10⁶ colony forming units (cfu) per gram.

The integrity or stability of a solid beverage flavorant composition may be tested using chromatography analysis to determine any reduction or change in the quantity of the ingredients in a solid beverage flavorant composition. A high-performance liquid chromatography (HPLC) column may be used to compare the presence of ingredients in a solid beverage flavorant composition stored over time and at varied temperatures and RH. A sample of a solid beverage flavorant composition may be diluted in Milli-Q water and analyzed using a HPLC to quantify the amounts of certain ingredients in the solid beverage flavorant composition. The quantity of sugar and any flavoring may be measured and quantified using a HPLC.

A Brix refractometer may be used to measure the sucrose or sugar content of a liquid to which a solid beverage flavorant composition has been added using refraction. The sugar content may be measured as degrees Brix (° Bx) for the number of grams of sugar present per 100 grams of liquid. The amount may be measured on a scale of one to 100. A Brix value may be used to as an objective measure of a subjective criteria related to flavor or sweetness.

### EXAMPLE 3

### Preparation of Flavored Solid Beverage Flavorant Compositions

Solid beverage flavorant compositions were prepared using the method of Example 1. Various flavored solid beverage flavorant compositions were prepared according to the following ingredients. Any one or more ingredients may be combined to prepare a solid beverage flavorant composition.

### Vanilla Sugar Cube

Sugar, vanilla bean and water were mixed together. The vanilla sugar cubes were placed into a dehydrator for 8 hours at 65° C. to dry the sugar cubes.

Initially the vanilla sugar cubes were prepared using vanilla extract. The vanilla extract was unable to bind in the original sugar cubes. The ingredients were modified to use vanilla bean powder in place of the vanilla extract. The use of vanilla bean powder instead of a vanilla extract reduced the volume of wet ingredients 104 in the sugar cube and formed a solid cube with smooth sides that was stable at room temperature.

### London Fog Sugar Cube

Two cornflower petals are placed into each cube of the mold. Stems are removed from the petals. Lavender sugar was prepared by mixing sugar, lavender oil, blue dye, red/pink dye and water together.

A batch of vanilla sugar was made separate from the lavender sugar. A quarter (¼) teaspoon of lavender sugar was added into each prepped mold and pushed down with a square stick, focusing on pushing the sugar down into the four corners of the mold. The remainder of the mold was filled with vanilla sugar. The London fog sugar cubes were placed into a dehydrator for 8 hours at 65° C. to dry the sugar cubes.

### Rose Sugar Cube

About one whole rose petal with any stems removed was placed into each cube mold. Broken pieces of rose petals were combined into the cubes. Sugar, crumbled rose petals, rose oil, red dye and water were mixed together.

The rose sugar cubes were placed into a dehydrator for 8 hours at 65° C. to dry the sugar cubes.

Initially rose sugar cubes were prepared using an alcohol-based rose extract. The rose flavor evaporated, and the rose sugar cubes did not dry sufficiently and produced crumbly sugar cubes. The alcohol-based rose extract was substituted with an oil-based rose extract and the amount of rose oil was increased. The substitution of the oil-based rose extract resulted in solid rose sugar cubes with smooth surfaces that were stable at room temperature.

### Salted Caramel Sugar Cube

Sugar, caramel powder, orange dye and water were mixed together. Once cubes were dry, the cubes were removed from molds and arranged close together on a tray. The cubes were misted lightly with water and sprinkled with fleur de sel. Each cube was sprinkled with some salt sprinkles. The cubes were misted lightly again and set to dry. The sugar cubes were either allowed to dry for two (2) hours at room temperature to set or were placed into a dehydrator for 8 hours at 65° C. before packaging.

A batch of sugar cubes may be produced in triple. For a triple batch the amount of orange or beet dye was multiplied by six.

### Champagne Sugar Cube Recipes

### Strawberry Sugar Cube

A piece of freeze-dried strawberry was placed into the molds. The freeze-dried pieces were no bigger than the size of a pea. For extra small pieces, two pieces are placed in the same cube of the mold. Sugar, strawberry powder, strawberry emulsion and hot water were mixed together.

The strawberry sugar cubes were placed into a dehydrator for 8 hours at 65° C. to dry the sugar cubes.

Initially the strawberry sugar cube was made using a strawberry powder. These strawberry sugar cubes did not dissolve in a carbonated liquid as expected or desired. The strawberry flavor was substituted with a water-soluble strawberry emulsion. This produced strawberry sugar cubes that dissolved in carbonated liquid.

### Raspberry Sugar Cube

A clump of freeze-dried raspberry was placed into the molds. The freeze-dried clumps were no bigger than the size of a pea. For extra small clumps, two clumps were placed in the same cube of the mold. Sugar, tartaric acid, water and raspberry emulsion were mixed together.

The raspberry sugar cubes were placed into a dehydrator for 8 hours at 65° C. to dry the sugar cubes.

Initially the raspberry sugar cubes were prepared using a raspberry extract. These raspberry sugar cubes did not have any raspberry flavor. The raspberry extract was substituted with a water-soluble raspberry emulsion and the amount of emulsion was increased. The amount of water added was also reduced and tartaric acid was added to the mixture 106. This produced a raspberry flavored sugar cube with smooth surfaces that was stable at room temperature.

### Peach Sugar Cubes

A piece of freeze-dried peach was placed into the molds. The freeze-dried pieces were no bigger than the size of a pea. For extra small pieces, two freeze-dried pieces are placed in the same cube of the mold. Sugar, peach extract or flavor, orange dye and water were mixed together.

The peach sugar cubes were placed into a dehydrator for 8 hours at 65° C. to dry the sugar cubes.

A batch of peach sugar cubes may be produced in triple. For a triple batch the amount of orange dye was multiplied by six.

### Citrus Sugar Cube Recipes

### Grapefruit Sugar Cube

Sugar, tartaric acid, citric acid, grapefruit oil, red/pink dye, red dye, pink dye and water were mixed together. The grapefruit sugar cubes were allowed to dry at room temperature, the cubes were removed from the molds, arranged close together on a tray and lightly sprayed with water. The grapefruit sugar cubes were dusted lightly with “rainbow” edible glitter. No second spray of water was applied to the sugar cubes. The grapefruit sugar cubes were not placed in the dehydrator to dry. The sugar cubes were allowed to set for two (2) hours prior to packaging.

A batch of sugar cubes may be produced in triple. For a triple batch the amount of dye was multiplied by six.

Initially, these grapefruit sugar cubes did not produce vibrantly colored sugar cubes. The orange dye originally added was removed and replaced with red/pink dye, red dye and pink dye. This produced a vibrantly colored grapefruit sugar cube with smooth surfaces that was stable at room temperature.

### Lemon Sugar Cube

Sugar, tartaric acid, citric acid, lemon powder, lemon oil, eggshell dye, yellow dye and water were mixed together. The lemon sugar cubes were allowed to dry at room temperature, the cubes were removed from the molds, arranged close together on a tray and lightly sprayed with water. The lemon sugar cubes were dusted lightly with “citrus” edible glitter. The lemon sugar cubes were not sprayed a second time with water. The lemon sugar cubes were not dehydrated. The lemon sugar cubes were allowed to dry for two (2) hours before packaging.

### Arcadia Orange Sugar Cube

Sugar, tartaric acid, citric acid, orange oil, orange dye, red/pink dye and water were mixed together. The Arcadia orange sugar cubes were allowed to dry at room temperature, they were removed from the molds, arranged close together on a tray and lightly sprayed with water. The Arcadia orange sugar cubes were dusted lightly with “orange crush” edible glitter. The Arcadia sugar cubes were not dried in a dehydrator.

A batch of sugar cubes may be produced in triple. For a triple batch the amount of orange dye was multiplied by six.

### Specialty Cocktail Sugar Cube Recipes

### Old-Fashioned Sugar Cube

A small chunk of orange peel was placed into each cube of the mold. Sugar, tartaric acid, orange oil, orange bitters, angostura bitters, orange dye and hot water were mixed together.

Initially, these old-fashioned sugar cubes did not dry fully and produced sugar cubes that crumbled easily. The amount of Angostura bitters and orange bitters was decreased, and the amount of water was increased. The old-fashioned sugar cubes were dried in a dehydrator for 12 hours at 65° C. or higher. This produced an old-fashioned sugar cube that dried completely and resulted in an old-fashioned sugar cube with smooth surfaces that was stable at room temperature. Old fashioned sugar cubes that were left to dry at room temperature produced sugar cubes that crumbled easily and were not solid. The use of the dehydrator solved this problem.

### Moscow Mule Sugar Cube

Sugar, ground ginger, tartaric acid, citric acid, ginger juice, lime juice and lime oil were mixed together. The Moscow mule sugar cubes were placed into a dehydrator for 8 hours at 65° C. to dry the sugar cubes.

After the Moscow mule sugar cubes were dried, they were removed from the molds and arranged in a grid on a tray. The Moscow mule sugar cubes were sprayed with a copper spray topping.

### Copper Spray Topping

1. One bottle of copper food paint was poured into a small spray bottle.
2. The empty food paint bottle was filled with hot water and shaken well.
3. The food paint was poured back into the spray bottle.
4. A black spray bottle was filled with hot water.
5. The spray bottle was shaken well with every use.

Initially these Moscow mule sugar cubes did not produce an adequate flavor. The amount of ginger juice was increased, the amount of lime juice was decreased, and the amount of lime oil was decreased. Citric acid was also added. These Moscow mule sugar cubes produced satisfactory authentic flavored Moscow mule sugar cubes.

### Manhattan Sugar Cube

Sugar, hot water, caramel dye, black cherry extract, vermouth extract, orange oil, angostura bitters and spiced cherry bitters were mixed together. The caramel dye was mixed with the hot water to melt the dye before adding to the mixture 106. The Manhattan sugar cubes were placed into a dehydrator for 8 hours at 65° C. to dry the sugar cubes.

### Mojito Sugar Cube

Ground mint leaves were placed into the molds sparingly. Sugar, unground mint leaves (spearmint leaves), tartaric acid, lime juice, lime oil and spearmint oil were mixed together.

The mojito sugar cubes were placed into a dehydrator for 8 hours at 65° C. to dry the sugar cubes.

### Mint Julep Sugar Cube

Sugar, spearmint oil, orange dye, yellow dye and hot water were mixed together. The mint julep sugar cubes were placed into a dehydrator for 8 hours at 65° C. to dry the sugar cubes.

Initially these mint julep sugar cubes were not drying fully and produced sugar cubes that were crumbly. The amount of water was increased to 5 times the original amount, the amount of spearmint oil was decreased to 2-3 times the original amount, the amount of orange dye was decreased to 1-2 times the original amount and the amount of yellow dye was decreased from to half the original amount. This resulted in a dry mint julep sugar cube with smooth surfaces that was stable at room temperature.

### Cosmo Sugar Cube

Sugar, citric acid, tartaric acid, beet powder, cranberry powder, orange oil, beet juice, cranberry concentrate and hot water were mixed together. The Cosmo sugar cubes were placed into a dehydrator for 6 hours at 65° C. to dry the sugar cubes.

Once the Cosmo sugar cubes were dry, they were removed from the molds, arranged close together on a tray and lightly sprayed with water. The Cosmo sugar cubes were sprinkled with “Hollywood red” edible glitter. The Cosmo sugar cubes were not sprayed with water a second time. The Cosmo sugar cubes were allowed to set for two (2) hours before packaging.

### Sleeve and Tray Assembly

The present invention may include a sleeve and tray assembly suitable for packaging, transporting, displaying, dispensing, or retaining products including the solid beverage flavorants described herein. Sleeve and tray assemblies described herein may retain an arrangement of cubes made available for removal in response to sliding the tray containing the cubes from the sleeve.

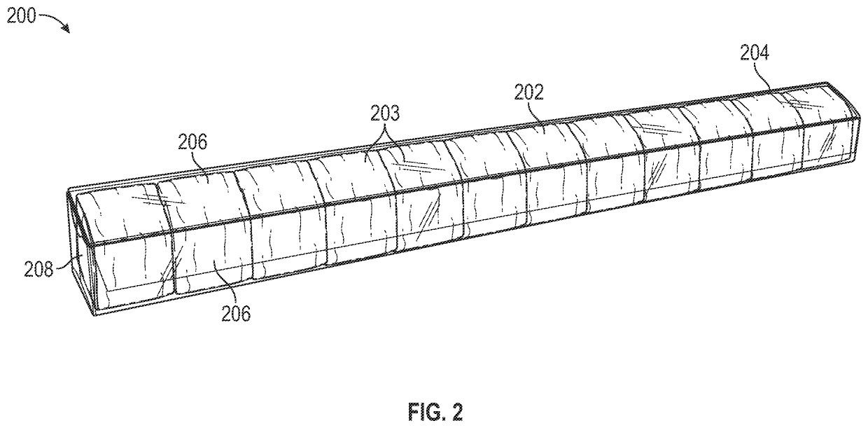

With reference to FIG. 2, a sleeve and tray assembly 200 is shown in an assembled configuration including flavorant 202 formed into cubes 203, in accordance with various embodiments. Sleeve 204 of sleeve and tray assembly 200 may comprise a rectangular cuboid geometry. Sleeve 204 may include four adjacent rectangular sides 206, also referred to herein as sidewalls. The four rectangular sides 206 may be substantially perpendicular to the adjoining rectangular sides 206 in an assembled configuration such that the body of sleeve 204 has a square cross-section. The square cross-section of the body may be similar to or congruent with end walls 208. End walls 208 may be disposed at either end of rectangular sides 206. End sides 208 may comprise a rectangular or square geometry.

In various embodiments, a tray of sleeve and tray assembly 200 may comprise four sides. Cubes 203 may be disposed in the tray and sleeve 204 in an assembled configuration. The tray may slide into and out from sleeve 204 to urge cubes into or out of sleeve 204. The tray may be visually obstructed or hidden by the edges of sleeve 204 and the texture and color of flavorant 202.

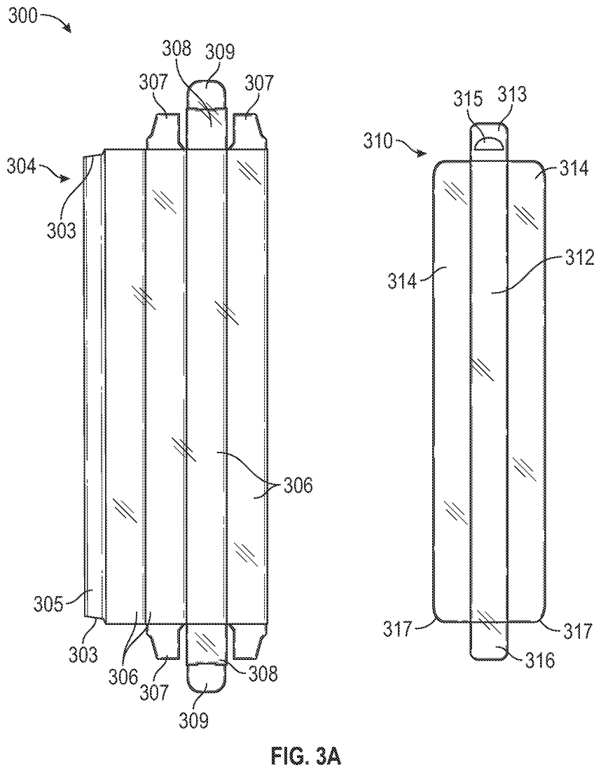

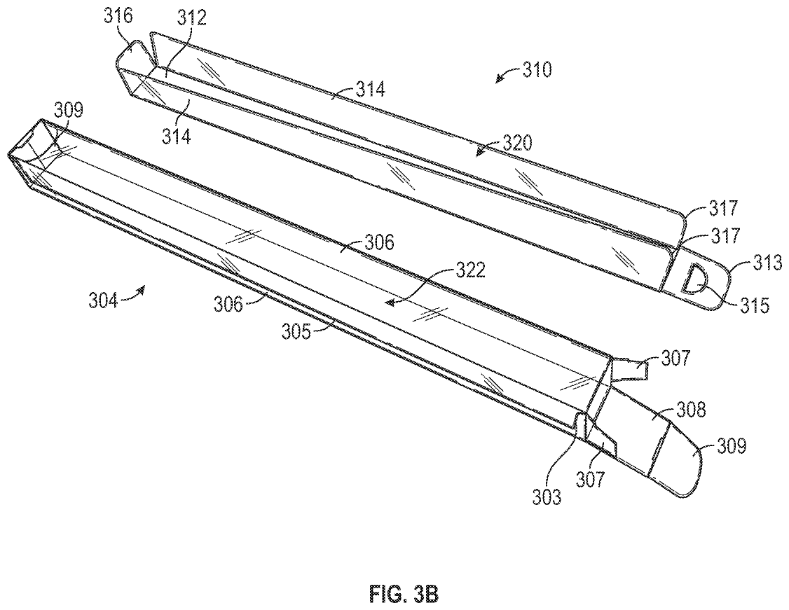

Referring now to FIGS. 3A and 3B, sleeve 304 and tray 310 of sleeve and tray assembly 300 are shown, in accordance with various embodiments. Sleeve 304 and tray 310 may be substantially flat before assembly, as shown in FIG. 3A. Sleeve 304 and tray 310 may be cut or stamped from a sheet of substantially flat material. The material used to form tray 310 and sleeve 304 may comprise plastic, paper, cardboard, sheet metal, or another suitable material with sufficient rigidity to maintain the shape of sleeve and tray assembly 200 (of FIG. 2) in response to assembly. The material used to form tray 310 and sleeve 304 may be transparent, translucent, colored, or opaque. For example, tray 310 and sleeve 304 may be formed by stamping, scoring, cutting, or manipulating a sheet of transparent plastic. In that regard, flavorant 202 (of FIG. 2) retained in sleeve and tray assembly 200 (of FIG. 2) may be visible through walls of sleeve 204 (of FIG. 2) and tray 210 (of FIG. 2).

In various embodiments, sleeve 304 in a flat configuration may comprise scoring, creases, or be predisposed to bending along the boundaries defining various sides. Sleeve 304 may include four sidewalls 306 having similar dimensions. For example, all sidewalls 306 may be rectangles approximately 17 mm by 108 mm. Tray 310 may comprise sidewalls 314 and base 312 that are rectangles approximately 16 mm by 106 mm. Tray 310 may have dimensions slightly smaller than sleeve 304 such that the assembled tray may fit completely within the assembled sleeve. As used herein in reference to dimensions, approximately may mean +/−5%, +/−10%, +/−15%, +/−20%, or +/−25%. Walls of tray 310 may have dimensions 0 to 3 millimeters, 1-2 millimeters, or 1 millimeter shorter than adjacent walls of sleeve 304. The tray of the present example may be configured to retain six cubes 203 (of FIG. 2). Cubes 203 (of FIG. 2) may have edges slightly smaller than the dimension of sidewall 314. For example, cubes 203 may comprise an edge length of approximately 15 mm to fit within the tray having an edge length of approximately 16 mm.

In another example, all sidewalls 306 may comprise rectangles approximately 205 mm by 17 mm. Tray 310 may comprise sidewalls 314 and base 312 that are rectangles approximately 16 mm by 203 mm. The tray of the present example may be configured to retain twelve cubes 203 (of FIG. 2). The foregoing examples are not intended to be limiting and are given for purposes of illustration only.

In various embodiments, sleeve 304 may comprise flaps 307 disposed at the distal ends of sleeve 304. Sleeve 304 may also comprise end walls 308 disposed between flaps 307. End wall 308 may be formed integrally with the adjacent sidewall 306. Flaps 307 may also be formed integrally with the adjacent sidewalls 306. End tab 309 may extend from end wall 308.

In various embodiments, assembly tab 305 may extend longitudinally along adjacent sidewall 306. Assembly tab 305 may comprise notched end 303. Notched end 303 may shorten the length of assembly tab 305 relative to adjacent sidewall 306. Notched end 303 may tend to reduce interference during assembly. Assembly tab 305 may be fixed to the sidewall 306 disposed on the opposite side of sleeve 304. Assembly tab 305 may be fused, glued, fastened, or otherwise adhered to sidewall 306 on the inside or outside of sleeve 304 in the assembled configuration.

In various embodiments, tray 310 may comprise base 312, sidewalls 314, and end stop 316. Pull tab 313 may extend from base 312 at a distal end opposite end stop 316. Pull tab 313 may define an opening 315 suitable for hanging an assembled sleeve and tray assembly. Tray 310 may translate in response to a pulling force or a pushing force exerted on tab 313.

With reference to FIG. 3B, sleeve and tray assembly 300 is shown in a partially assembled configuration, in accordance with various embodiments. Adjacent components of sleeve 304 and tray 310 may be folded together at approximately 90-degree angles to form an elongated box and tray in response to being assembled. As used herein in reference to angles, approximately may mean +/−5 degrees, +/−10 degrees, or +/−15 degrees. Sleeve 304 and tray 310 may comprise scoring, creases, or be predisposed to bending along the boundaries defining various sides and features to facilitate folding during assembly. For example, base 312 of tray 310 may be surrounded by scoring along four edges to allow adjacent sides to fold at 90 degrees relative to base 312.

In various embodiments, sleeve 304 may define a cavity 322 to receive tray 310. Cavity 322 may be defined between four sidewalls 306. In that regard, cavity 322 may be elongated and may span the length of sleeve 304. Tray 310 may define a channel 320 to receive cubes 203 (of FIG. 2). Tray 310 may slide into cavity 322. End walls 308 may be folded into a closed position to completely enclose tray 310 and cubes 203 in sleeve and tray assembly 300.

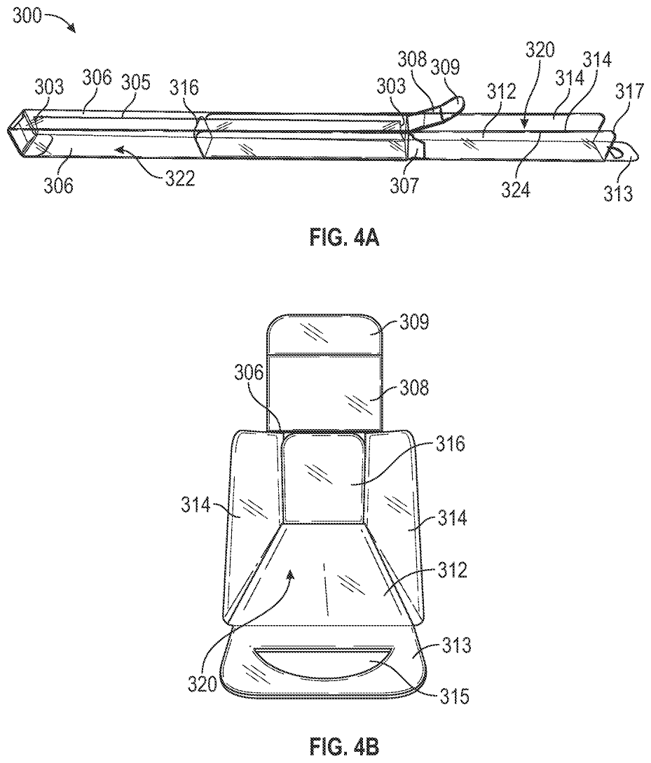

Referring now to FIGS. 4A and 4B, sleeve and tray assembly 300 is shown with sleeve 304 and tray 310 in an assembled configuration, in accordance with various embodiments. Tray 310 may extend from sleeve 304 in the depicted configuration. Tray 310 may define channel 320 between sidewalls 314 and base 312. End stop 316 operate as the terminus of channel 320. End stop 316 may translate along cavity 322 in response to tray 310 sliding into or out from sleeve 304. In that regard, tray 310 with end stop 316 may urge contents of channel 320 (e.g., cubes of solid flavorant) along, into, or out from sleeve 304 in response to tray 310 translating relative to cavity 322 defined by sleeve 304. Rounded corners 317 of tray 310 may reduce interference when inserting the leading end of tray 310 into sleeve 304.

In various embodiments, sidewalls 314 of tray 310 may contact sidewall 306 of sleeve 304 disposed opposite base 312. Tray 310 may fit snugly into sleeve 304 in a press fit arrangement. Contents of tray 310 (not shown) may tend to press sidewalls 314 of tray 310 into adjacent sidewalls 306 of sleeve 304. Base 312 of tray 310 may tend to press against an adjacent sidewall 306 of sleeve 304. Base 312, sidewalls 314, and the edge 324 of sidewalls 314 opposite base 312 may slideably engage sidewalls 306 of sleeve 304 in response to tray 310 translating into or out from cavity 322. Operators may use tab 313 to grip tray 310 and motivate translation of tray 310 in sleeve 304 by applying a pushing or pulling force.

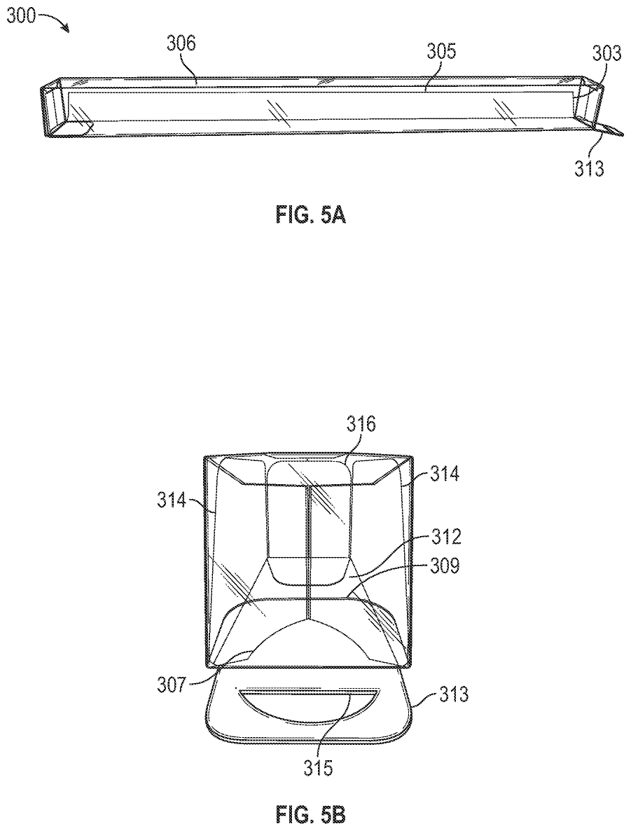

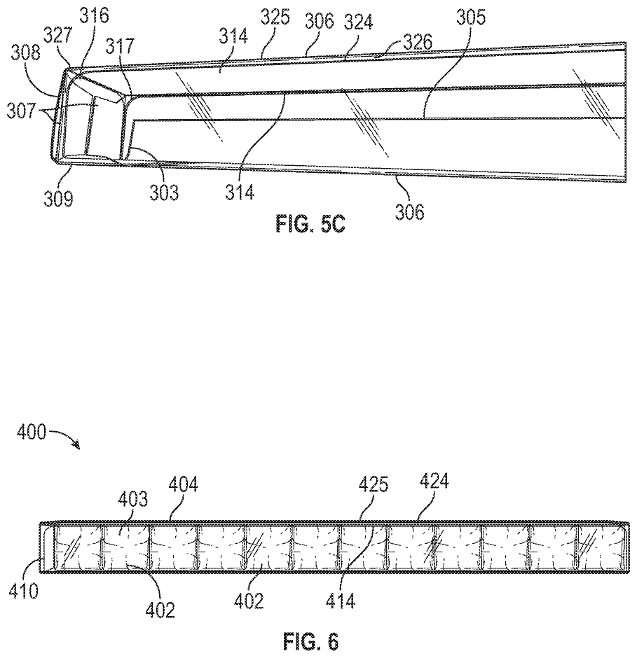

With reference to FIGS. 5A, 5B, and 5C, sleeve and tray assembly 300 is shown in a closed configuration, in accordance with various embodiments. Tray 310 may slide completely into cavity 322. Flaps 307 may fold inward towards tray 310. End wall 308 may close downward toward tab 313 to cover and retain flaps 307 in a closed position. End tab 309 may slide over base 312 and between sidewalls 314 of tray 310. End tab 309 may rest beneath a cuboid payload in the closed position. Friction between end tab 309, the payload, base 312, and sidewalls 314 may tend to retain end wall 308 in a closed position. Tab 313 defining opening 315 may protrude from sleeve 304 in the closed position.

Referring now to FIG. 5C, a detail view of tray 310 engaging sleeve 304 is shown in a closed configuration, in accordance with various embodiments. End wall 308 may form the outermost layer of material in sleeve and tray assembly 300. Flaps 307 may sandwich between end wall 308 of sleeve 304 and end stop 316 of tray 310. End tab 309 may be pinched between tray 310 and a sidewall 306 of sleeve 304 to retain end wall 308 in a closed position.

In various embodiments, rounded corners 317 may reduce interference between tray 310 and sleeve 304 during closure of flaps 307 and end wall 308. Edge 324 of sidewall 314 may contact edge 325 of sidewall 306. Edge 324 of sidewall 314 and edge 325 of sidewall 306 may define a gap 326 between them. Gap 326 may be zero where edge 324 contacts edge 325. Gap 326 may be small enough to visually obscure the presence of tray 310 in sleeve 304 (e.g., 1 millimeter, 2 millimeters, or 3 millimeters). In that regard, edge 324 of tray 310 may be visually obstructed by edge 325 of sleeve 304 in the closed configuration. A gap between end stop 316 and edge 327 of sleeve 304 may be similarly small or zero. Some or all edges of tray 310 may be visually obstructed in a similar or same manner by adjacent edges of sleeve 304.

With reference to FIG. 6, sleeve and tray assembly 400 is shown containing solid flavorant 402 formed into cubes 403, in accordance with various embodiments. Cubes 403 may be visible through sleeve 404 and tray 410. The textures or colors of flavorant 402 may be visible through tray 310 and sleeve 304. The textures or colors of flavorant 402 may serve to obscure the edges and corners of tray 310 and sleeve 304.

In various embodiments, edge 424 of sidewall 414 of tray 410 may contact or define a small gap between edge 425 of sleeve 404. Edges of tray 410 may be substantially hidden within sleeve 404 to inhibit visual detection of tray 410 in sleeve 404 in the closed configuration. The presence of cuboid payload may obscure the edges and walls of tray 410 in sleeve 404. In that regard, the snug fit between tray 410 and sleeve 404 along with the textured surfaces of flavorant 402 may visually conceal the presence of tray 410 in response to a transparent or translucent sleeve and tray assembly 400 being in a closed configuration. Sleeve and tray assembly 400 may tend to minimize degradation of flavorant 402 and store flavorant 402 in a stable state.

Benefits, other advantages, and solutions to problems have been described herein with regard to specific embodiments. Furthermore, the connecting lines shown in various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article or apparatus that comprises a list of elements does not include only those elements but may include other elements not expressly listed or inherent to such process, method or article, or apparatus.

What is claimed is:

1. A sleeve and tray assembly, comprising:
a transparent sleeve having a rectangular geometry and defining a cavity between a plurality of sidewalls and a plurality of end walls;
a transparent tray disposed within the cavity, the transparent tray comprising:
a base;
a first sidewall extending from a first edge of the base;
a second sidewall extending from a second edge of the base opposite the first edge; and
an end stop extending from a third edge of the base extending between the first edge and the second edge, wherein the base, the first sidewall, and the second sidewall define a channel terminated by the end stop; and
a plurality of cubes comprising a flavorant disposed in the channel,
wherein a surface texture of the flavorant is visible through the transparent tray and the transparent sleeve, and
wherein an edge of the transparent tray is visually obscured by an edge of the transparent sleeve and the surface texture of the flavorant.

2. The sleeve and tray assembly of claim 1, wherein the flavorant comprises sugar, a flavoring, water, emulsion, a dye, and any combination thereof, wherein the flavorant is stable at room temperature.

3. The sleeve and tray assembly of claim 1, wherein the flavorant further comprises a garnish or dehydrated botanical ingredient that is visible through the transparent tray and the transparent sleeve.

4. The sleeve and tray assembly of claim 2, wherein the flavorant is formed into a plurality of cubes with substantially smooth surfaces including the surface texture of the flavorant.

5. The sleeve and tray assembly of claim 3, wherein the first sidewall of the transparent tray between 0 millimeter and 3 millimeters shorter than a sidewall of the transparent sleeve from the plurality of sidewalls.

6. The sleeve and tray assembly of claim 3, wherein an edge of the first sidewall of the transparent tray contacts a sidewall from the plurality of sidewalls of the transparent sleeve.

7. The sleeve and tray assembly of claim 3, wherein the transparent tray comprises rounded corners to reduce interference in response to insertion of the transparent tray into the cavity defined by the transparent sleeve.

8. The sleeve and tray assembly of claim 3, wherein the end stop of the transparent tray urges the cubes out of the transparent sleeve in response to the transparent tray translating out from the transparent sleeve.

9. The sleeve and tray assembly of claim 3, further comprising a tab formed integrally with the base of the transparent tray and extending from the transparent sleeve in response to the sleeve and tray assembly being in a closed position.

10. The sleeve and tray assembly of claim 9, wherein the transparent tray is configured to translate out of the transparent sleeve in response to a pulling force exerted on the tab.

11. The sleeve and tray assembly of claim 9, wherein the tab defines an opening to hang the sleeve and tray assembly.

12. A sleeve and tray assembly comprising:
a sleeve defining a cavity between a plurality of sleeve sidewalls and a plurality of sleeve end walls;
a tray disposed within the cavity, the tray comprising:
a base;
a first sidewall extending from a first edge of the base;
a second sidewall extending from a second edge of the base opposite the first edge; and
an end stop extending from a third edge of the base, wherein the base, the first sidewall, and the second sidewall define a channel terminated by the end stop; and
a plurality of cubes disposed in the channel.

13. The sleeve and tray assembly of claim 12, wherein the plurality of cubes comprise substantially smooth surfaces including a surface texture of at least one of sugar, a garnish, or a botanical ingredient.

14. The sleeve and tray assembly of claim 13, wherein the sleeve and the cubes visually obscure the edges of the tray in response to the sleeve and tray assembly being in a closed configuration.

15. A method of packaging a solid beverage flavorant, comprising:
placing a mold comprising individual sections onto a tray;
combining one or more dehydrated botanical ingredients and one or more wet ingredients to form a mixture;
packing the mixture into an individual section of the mold having a cuboid geometry;
smoothing an exposed surface of the mixture to form a substantially smooth surface; and
drying the mixture to form a solid beverage flavorant composition having a cuboid geometry with substantially smooth surfaces, wherein the solid beverage flavorant composition is stable at room temperature.

16. The method of claim 15, wherein a further comprising placing at least one of a dehydrated botanical ingredient or a garnish into the individual section of the mold to expose the dehydrated botanical ingredient or garnish from the substantially smooth surfaces.

17. The method of claim 16, wherein the mixture is dried in a dehydration apparatus at 65° C. for 8 hours.

18. The method of claim 16, further comprising placing the solid beverage flavorant composition into a tray having a rectangular base, two rectangular sidewalls extending from the base, and a rectangular end stop extending from the base.

19. The method of claim 18, further comprising sliding the tray containing the solid beverage flavorant into a sleeve.

20. The method of claim 19, wherein the tray and the sleeve are at least one of transparent or translucent.
